(19) United States
(12) Patent Application Publication
(10) Pub. No.: US 2003/0149939 A1
(43) Pub. Date: Aug. 7, 2003

(54) System for organizing and navigating through files

(76) Inventors: Paul M. Hubel, Mt. View, CA (US); Mark D. Seaman, Greeley, CO (US); K. Douglas Gennetten, Ft. Collins, CO (US); Charles H. McConica, Corvallis, OR (US)

Correspondence Address: HEWLETT-PACKARD COMPANY, Intellectual Property Administration, P.O.Box 272400, Fort Collins, CO, 80527-2400, US

(21) Appl. No.: 10/072,519

(22) Filed: Feb. 5, 2002

(51) Int. Cl. G06F 15/00

(52) U.S. Cl. 715/526

(57) ABSTRACT

A system for organizing and navigating through files allows a user to view and navigate through files in a rendering of three-dimensional space. The system comprises a plurality of files, each file comprising at least two attributes, a first code segment for mapping the at least two attributes into at least two dimensions, a graphical user interface for rendering the at least two attributes representing each file into three-dimensional space, where an icon represents each file, and where the graphical user interface allows a user to navigate through the three-dimensional space to view the icons representing each of the files. Embodiments of the invention map files into three-dimensional space according to values assigned to the attributes and allow the user to view and manipulate the files in three-dimensional space.

### BACKGROUND OF THE INVENTION

1. Field of the Invention

The invention relates generally the electronic storage and filing of documents, and, more particularly, to a system and related method for organizing and navigating through the files using a two dimensional rendering of three-dimensional (3D) space.

2. Related Art

As personal computers and alternative personal computing devices become more and more widespread, more and more files are being stored on these devices. For example, the advent and proliferation of digital photography is resulting in more and more large files being stored on computing devices. When described in the context of digital photography, the digital images are generally stored as image files. However, regardless of the type of information stored, the information is typically stored as one or more files.

When an individual desires to view these files, the individual generally opens, or launches, a file management program. Depending on the type of computing device and the type of file management system running on the computing device, the user is typically presented with a list of files that contain one or more documents. The documents may be text (in the case of a word processing type document) or may be other types of documents (for example, in the case of photography, the files may be image files).

Regardless of the type of files, the file management program typically displays the list of files so that the user may decide which file to open and view. Unfortunately, in the case of image files, the above-described conventional file management system may not present the user with sufficient information to determine which file the user may wish to view, or further process. The term “further process” generally means to either modify or further manipulate the file. For example, in the case of an image file, a user may wish to transfer the image electronically to another computing device for viewing by another individual.

In order for a user to locate a particular file using a conventional file management system, the user must navigate through long lists of file names that may appear confusingly similar. Unfortunately, available file management systems fail to offer the user an intuitive manner in which to view the files stored on the computing device.

Therefore, it would be desirable to have a file management system that offers the user an alternative manner of organizing and navigating through the files stored on a computing device.

### SUMMARY

A system and method for organizing and navigating through files is disclosed. The system comprises a plurality of files, each file comprising at least two attributes, a first code segment for mapping the at least two attributes into at least two dimensions, a graphical user interface for rendering the at least two attributes representing each file into three-dimensional space, where an icon represents each file, and where the graphical user interface allows a user to navigate through the three-dimensional space to view the icons representing each of the files. An aspect of the invention maps files into three-dimensional space according to values assigned to the attributes and allows the user to view the files in three-dimensional space.

The method for organizing and navigating through files comprises providing a plurality of files, each file comprising at least two attributes, mapping the at least two attributes into at least two dimensions, rendering the at least two attributes representing each file into three-dimensional space, where an icon represents each file, and navigating through the three-dimensional space to view the icons representing each of the files.

Other systems, methods, features, and advantages of the present invention will be or become apparent to one with ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Embodiments of the invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplar processing environment in which an embodiment of the invention resides.

FIG. 2 is a flowchart illustrating the operation of the file management software of FIG. 1.

FIG. 3 is a diagram illustrating the mapping of the photo file attributes of FIG. 1.

FIG. 4 is a graphical representation of the three-dimensional scene rendered in FIG. 3.

### DETAILED DESCRIPTION OF THE PREFERRED EMBODIMENT

The system for organizing and navigating through files can be implemented in software (e.g., firmware), hardware, or a combination thereof In one embodiment, the system for organizing and navigating through files is implemented using a personal computer (PC) or other personal computing device, such as a personal digital assistant (PDA) or even a digital camera. However, regardless of the manner of implementation, the software portion of the invention can be executed by a special or general purpose computer, such as a personal computer (PC; IBM-compatible, Apple-compatible, or otherwise), workstation, minicomputer or mainframe computer. Furthermore, the invention may be implemented in other processing or computing devices, such as, for example but not limited to, a digital camera, a palmtop computer, a personal data assistant (PDA), a computer game console, etc. Furthermore, while described below as organizing and navigating through image files, the invention is applicable to any type of file stored on a computing device.

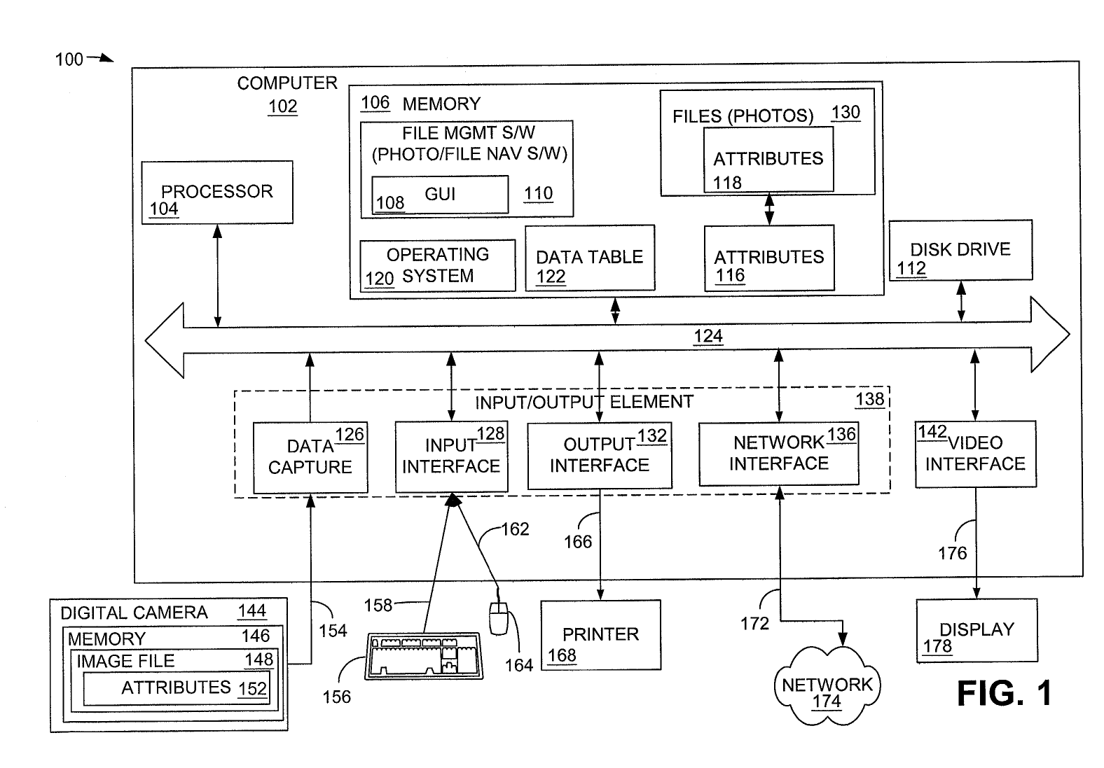

FIG. 1 is a schematic view illustrating an exemplar processing environment 100 in which the invention resides. As mentioned above, in one embodiment, the system for organizing and navigating through files is implemented primarily in software using a general purpose computer, such as the computer 102 shown in FIG. 1

The computer 102 includes a memory, which includes software in the form of a file management code segment 110. In the description to follow, the file management code segment 110 will be described in the context of enabling a user to navigate through image files presented in three-dimensional (3D) space. However, the file management code segment 110 can be used to present any type of file to the user and allow the user to navigate through the files in a 3D rendered environment. The file management code segment 110 and other software and hardware elements (to be discussed with respect to FIG. 1) work in unison to implement the functionality of the invention.

Generally, in terms of hardware architecture, as shown in FIG. 1, the computer 102 includes a processor 104, a memory 106, a disk drive 112, a video interface 142 and an input/output element 138 that are connected together and can communicate with each other via a local interface 124. The local interface 124 can be, for example but not limited to, one or more buses or other wired or wireless connections, as is known to those having ordinary skill in the art. The local interface 124 may have additional elements, which are omitted for simplicity, such as buffers (caches), drivers, and controllers, to enable communications. Further, the local interface 124 includes address, control, and data connections to enable appropriate communications among the aforementioned components. The input/output element 138 includes a data capture element 126, an input interface 128, an output interface 132 and a network interface 136, each in communication with the local interface 124. The disk drive 112 can be any storage element or memory device, and as used herein, refers to a removable memory media such as a compact flash type memory.

The processor 104 is a hardware device for executing software that is stored in memory 106. The processor 104 can be any custom made or commercially available processor, a central processing unit (CPU) or an auxiliary processor among several processors associated with the computer 102, and a microchip-based microprocessor or a macroprocessor. Examples of suitable commercially available microprocessors are as follows: a PA-RISC series microprocessor from Hewlett-Packard Company, a StrongARM™ processor from Intel Corporation, an 80x86 or Pentium series microprocessor from Intel Corporation, a PowerPC microprocessor from IBM Corporation, a Sparc microprocessor from Sun Microsystems, Inc., or a 68xxx series microprocessor from Motorola Corporation.

The memory 106 can include any one or a combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 106 may incorporate electronic, magnetic, optical, and/or other types of storage media. Note that the memory 106 can have a distributed architecture, where various components are situated remote from one another, but can be accessed by the processor 104.

The input interface 128 can receive commands from, for example, keyboard 156 via connection 158 and from mouse 164 via connection 162 and transfer those commands over the local interface 124 to the processor 104 and the memory 106. Other input devices, for example but not limited to, a touch sensitive input device, a joystick, an interactive feedback glove, and a pointing device, can also be used to input commands into the processor 104, depending upon the type of processing system that is executing the file management code segment 110. For example, if the file management software is executed in a computer game console, a joystick is a likely input device. All such input devices are contemplated within the scope of the invention.

In accordance with an embodiment of the invention, a digital camera 144 is coupled to the computer 102 via connection 154 and the data capture element 126. The data capture element 126 is part of the input/output element 138 and receives inputs from the digital camera 144. The digital camera 144 includes a memory 146. The memory 146 can be any type of memory employed in digital cameras, and can be, for example, but not limited to, a fixed or removable memory media. In operation, the digital camera 144 stores images in the form of an image file 148. The image file may include embedded attributes 152. Alternatively, the image file 148 may have associated with it external attributes. The attributes represent the characteristics of the image file 148 and will be used by the file management code segment 110 to develop a data table 122 that is stored in memory and used to map the image file 148 into 3D space, as will be described below.

When digital images (image file 148) are captured and stored in a digital camera 144, it is often desirable to transfer the image file 148 from the memory 146 to, for example, a computer 102. When the image file 148 is transferred to the computer 102, the image file 148 can be further manipulated, as will be described below. Alternatively, instead of connecting the digital camera 144 directly to the computer 102, the memory element 146, which can be, for example, a removable memory element, can be inserted directly into the disk drive 112 to load the image file 148 onto the computer 102. When the image file 148 is loaded onto the computer 102, the image file 148 is stored in the memory 106 as photo file 130 having internal attributes 118 and external attributes 116. Typically, a plurality of photo files 130 are stored in the memory 106.

The video interface 142 supplies a video output signal via connection 176 to the display 178. The display 178 can be a conventional CRT based display device, or can be any other display device, such as a liquid crystal display (LCD) or other type of display.

The output interface 132 sends printer commands via connection 166 to the printer 168. The network interface 136, can be, for example, a network interface card located in the computer 102, a dial-up modulator/demodulator (modem), a digital subscriber line (DSL) transceiver or cable modem, or any other communication device capable of connecting the computer 102 to an external network 174. An image file can also be transferred to the computer 102 via the network 174 using the network interface 136.

The software in memory 106 may include one or more separate programs, each of which comprise one or more code segments, which are an ordered listing of executable instructions for implementing logical functions. In the example of FIG. 1, the software in the memory 106 includes the file management code segment 110, which includes a graphical user interface (GUI) 108. The memory 106 also includes a suitable operating system (O/S) 120. Further, the memory 106 includes photo files 130 and a data table 122, the formation of which will be explained in detail below.

The file management software is a software component that organizes one or more photo files 130 according to selected attributes and allows a user of the computer 102 to navigate through the photo files 130 in a real-time rendering of 3D space by using the GUI 108 to locate the photo files 130 in 3D space and present the user a rendering of a 3D environment.

With respect to the operating system 120, a non-exhaustive list of examples of suitable commercially available operating systems 120 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 120 essentially controls the execution of other computer programs, such as the file management code segment 110 and the GUI 108, and provides scheduling, input-output control, file and data management, memory management, and communication control and related services. The processor 104 and operating system 120 define a computer platform, for which application programs, such as the file management code segment 110, in higher level programming languages are written. The file management code segment 110 includes the software that allows the computer 102 to organize and map the photo files into a rendering of 3D space for presentation to a user.

If the computer 102 is a PC, the software in the memory 106 further includes a basic input output system (BIOS) (omitted for simplicity). The BIOS is a set of essential software routines that test hardware at startup, start the O/S 120, and support the transfer of data among the hardware devices. The BIOS is stored in ROM so that it can be executed when the computer 102 is activated.

When the computer 102 is in operation, the processor 104 is configured to execute software stored within the memory 106, to communicate data to and from the memory 104 and to generally control operations of the computer 102 pursuant to the software. The file management code segment 110, GUI 108 and the O/S 120, in whole or in part, but typically the latter, are read by the processor 104, perhaps buffered within the processor 104, and then executed.

When the system for organizing and navigating through files is implemented primarily in software, as is shown in FIG. 1, it should be noted that the file management code segment 110 and the GUI 108 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The file management code segment 110 and the GUI 108 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the system for organizing and navigating through files can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One of the more typical manipulations performed on the image file 148 is the electronic transfer of the image file 148 to the computer 102 for organization, storage and possible transfer to another computer for file sharing purposes. For example, it is common to append the image file 148 to an electronic mail (email) message and send the image file 148 to friends or family. The emailed image file 148 can then be viewed by others.

However, when a user attempts to determine which image files to send, a conventional file management system affords the user no way to distinguish between files, other than by basic file name and possibly file size. In accordance with an embodiment of the invention, when the image file 148 is transferred to the computer 102 and stored in the memory 106, the file management code segment 110 can organize the photo file 130 based on internal attributes 118 and external attributes 116 (but not necessarily one of each), and then present the photo file 130 to the user in a rendering of a 3D environment, through which the user can view the photo file based on selected attributes.

For example, for many photo files it would be advantageous to present the photo file to a user based on the time the photograph corresponding to the photo file 130 was taken. Another attribute of the photo file 130 may be location, meaning the location in which the photograph was taken. The file management software 110 to be described below organizes the photo files 130 based on the attributes selected by the user of the computer 102 and renders the photo files 130 to the user in a two dimensional rendering of 3D space, through which the user navigates to locate a particular photo file or group of photo files.

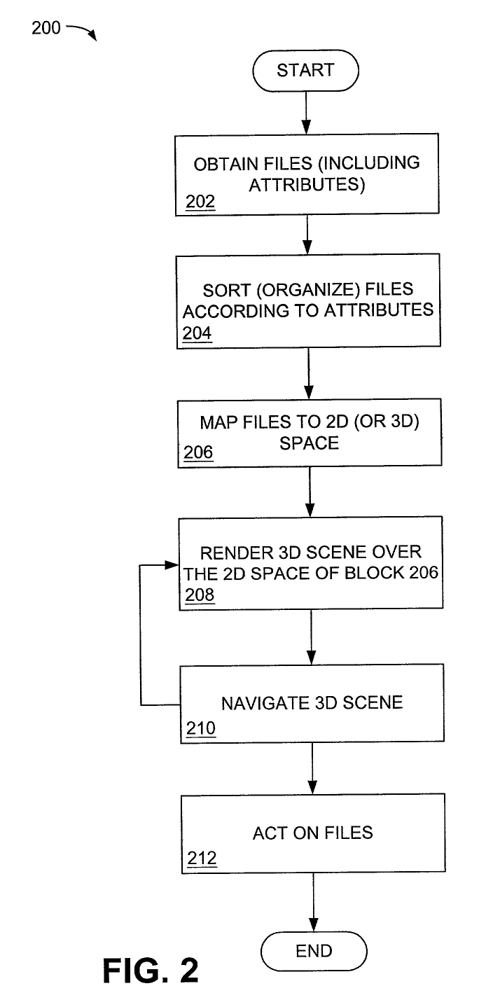

FIG. 2 is a flow chart describing the operation of the file management software 110 of FIG. 1. The flow chart of FIG. 2 shows the architecture, functionality, and operation of a possible implementation of the file management code segment of FIG. 1. In this regard, each block represents a module, segment, or portion of code, which comprises one or more executable instructions for implementing the specified logical function(s). It should also be noted that in some alternative implementations, the functions noted in the blocks may occur out of the order noted in FIG. 2. For example, two blocks shown in succession in FIG. 2 may in fact be executed substantially concurrently or the blocks may sometimes be executed in the reverse order, depending upon the functionality involved, as will be further clarified below.

In block 202, the computer 102 of FIG. 1 obtains files and associated attributes. The files can be image files that are transferred to the computer 102 from, for example, a digital camera 144 (FIG. 1). Alternatively, the files can be transferred to the computer 102 using, for example, a disk or via the network 174. The image files 130 transferred to the computer include internal attributes 118 and external attributes 116. As mentioned above, the internal attributes 118 are those that can be extracted from the image file 130 while the external attributes 116 are external to the image file but associated therewith. As shown in FIG. 1, the photo files 130 are stored in memory 106. Essentially, the internal attributes 118 and external attributes 116 represent all information pertaining to the photo files 130.

In block 204, the photo files 130 are sorted (organized) according to the attributes. Attributes associated with the photo files 130 (FIG. 1) may include, for example but not limited to, time (such as the time at which the photograph was taken), location (for example the geographic location or possibly a global positioning system (GPS) location), people (the subject of the photograph), a subjective rating of the importance of the photograph, the number of times on which an operation (such as, for example, the number of times the photograph was accessed, enlarged, or emailed) was performed on the photograph, file type, file size, etc. When used as an attribute, the people attribute refers to the ability of software to perform face recognition on the photograph, and thereby categorize photographic images by subject. The file type attribute may include, for example but not limited to, a .jpg, .gif, or other type file. The file size attribute refers to the amount of memory location that the photo file occupies.

In block 206, each photo file 130 (and more accurately the attributes that are associated with the photo file 130) are mapped into at least two-dimensional space. More broadly stated, the n dimensions of attributes (i.e., time, location, people, type, size, etc.) are mapped into at least two-dimensional, and possibly, three-dimensional space. As will be described in detail below, these at least two dimensions are then rendered in 3D space so that a user of the computer may view the files in a rendering of a 3D environment. In this manner, it is possible to have a two or three-dimensional representation of each photo file 130 in 3D space.

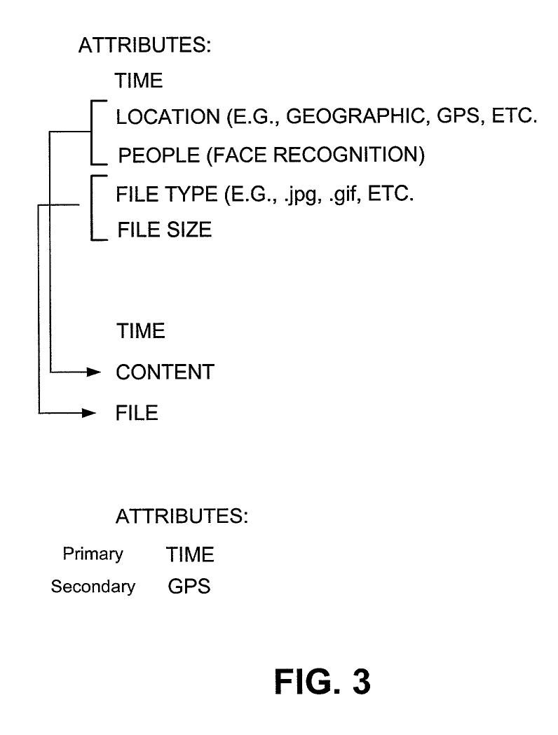

FIG. 3 is a diagram illustrating the mapping of the photo file attributes of FIG. 1. For example, the time attribute is considered a primary attribute and represents one of the multiple dimensions in which the attributes are mapped. In this example, because there are n dimensions to be mapped into a rendering of 3D space, the location attribute and the people attribute can together define a content attribute. Each of the attributes may be assigned a numerical value, so the content attribute may be a numerical value that includes the numerical value of the location attribute and the people attribute. For example, a GPS location and a face recognition categorization of a person in a photo can be assigned a numerical value. This single value comprises the content attribute.

In order to accomplish this, the microprocessor 104 of FIG. 1 executes the file management software 110 to process the attributes and assign a numerical value to each attribute. This numerical value assigned to each attribute is then inserted into a data table 122 (FIG. 1), which is created by the file management software 110 and stored in memory 106. The data table 122 includes information from each of the photo files 130 and for each of the attributes 116 and 118 in each of the photo files 130.

Still referring to FIG. 3, a file type attribute and a file size attribute can define a single file attribute, which is a single numerical value that encompasses the numerical values of both the file type attribute and the file size attribute. In this manner, the n (in this example, five (5)) attributes of time, location, people, file type and file size are mapped into three dimensions (time, content, file attributes). However, for simplicity of explanation, it is also possible to map the n attributes into two dimensions. Preferably, the two dimensions include time and location. In this example, time is considered a primary attribute and location, which can be, for example, a GPS coordinate location represented by a numerical value, is a secondary attribute.

Referring again to FIG. 2, in block 208 the file management software 110 together with the GUI 108 provides a two dimensional rendering of a 3D scene using the attributes that were mapped into two or three dimensions above in block 206. In block 210, a user of the computer 102 uses the GUI 108 to navigate through the rendered 3D scene created in block 208. As the user navigates through the 3D scene, the 3D scene is continually updated and re-rendered in block 208. In block 212, a user of the computer 102 can act on each of the photo files 130 by, for example, selecting, viewing, editing, printing, zooming (enlarging), or saving the files to a different location.

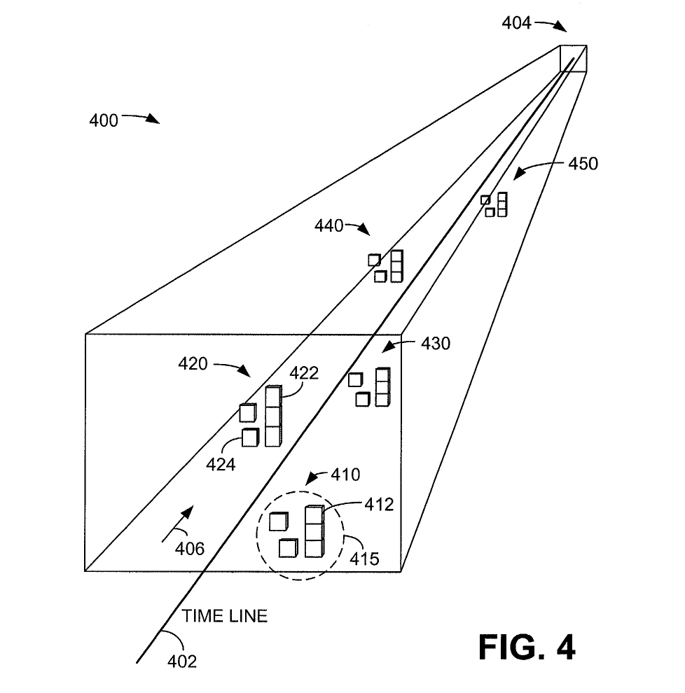

FIG. 4 is a graphical representation of 3D scene 400 rendered in block 208 of FIG. 3. The 3D scene 400 depicts the “landscape” presented to a user of the processing environment 100 from a particular vantage point and includes a primary attribute (in this example time, represented using the timeline indicated by reference numeral 402), and a secondary attribute, in this example location. However, the 3D scene 400 also illustrates the use of a third dimension (to be described with respect to the file 422). In FIG. 4, a user of the computer 102 uses the mouse 164 and optionally the keyboard 156 to navigate through the 3D scene 400 that is shown on the display 178. The 3D scene 400 is a two-dimensional rendering of a 3D scene including the attributes associated with a photo file 130 (FIG. 1). As the user navigates through the 3D scene 400, the user views groups of files that are arranged based on their attributes. In FIG. 4, the files are arranged with respect to the timeline 402 (i.e., the primary attribute) and distance (i.e., the secondary attribute corresponding to location) from the timeline 402.

For example, the file group 410 includes a number of files, an exemplar one of which is illustrated using reference numeral 412. The file 412 corresponds to the photo file 130 shown in FIG. 1 and is located in the 3D scene 400 based on the time attribute and the location attribute. For example, the file 412 is located at a particular point on timeline 402 and at a particular distance from the timeline 402. In this manner, the user views the group of files 410 based on the attributes (time and location) mapped into the 3D scene 400. Further, additional groups of files 420, 430, 440 and 450 are all presented in the 3D scene 400 along the timeline 402. For example, the user navigates through the 3D scene 400 from a vantage point such as that indicated by arrow 406 towards a vanishing point 404 to view the groups of files. In this manner, a user of the computer 102 and the file management software 110 can spatially view groups of files in a 3D environment.

The GUI 108 can adjust the vantage point displayed to a user to explicitly include zooming in on a desired area, with appropriate scaling of the Z dimension (timeline 402) to retain visibility of the groups of files.

The user of the system can select, or highlight, a group of files (i.e., file group 410) by using the mouse 164 (FIG. 1) to draw a bounding box or circle 415 around the file group 410. In this manner, the file group 410 can be selected in the 3D scene 400 and can be zoomed in on to further view the file group 410, and to view particular files in the file group.

In addition, the 3D scene 400 could be accessed using, for example, a database query by accessing the data table 122 (FIG. 1). Each axis can be selected from a menu of all available attributes. Then, for instance, all the pictures (over all time and location) that include a particular individual, or that have been used frequently, can be ranked by, for example quality of the photograph, and accessed. Such searches could be nested and redisplayed to find the times and locations that correspond to the desired files.

To illustrate a third attribute assigned to some of the files in FIG. 4, the group of files 420 includes a file 422. The file 422, in addition to being located at a particular point on timeline 402 and at a particular distance from timeline 402, is illustrated as being of a different size than the other files in FIG. 4. In this manner, a third attribute (file size) can be used to organize and sort files using three dimensions and then be presented to a user in the three-dimensional scene 400. Further, while a user is navigating through the three-dimensional scene 400 the user can manipulate each of the individual files as required.

It will be apparent to those skilled in the art that many modifications and variations may be made to the preferred embodiments of the present invention, as set forth above, without departing substantially from the principles of the present invention. For example, the system for organizing and navigating through files can be used in any computer environment to organize and render files to a user in 3D space. All such modifications and variations are intended to be included herein within the scope of the present invention, as defined in the claims that follow.

What is claimed is:

1. A system for organizing and navigating through files, comprising:
means for providing a plurality of files, each file comprising at least two attributes;
means for mapping the at least two attributes into at least two dimensions;
means for rendering the at least two attributes representing each file into three-dimensional space, where an icon represents each file; and
means for navigating through the three-dimensional space to view the icons representing each of the files.

2. The system of claim 1, wherein the attributes define the position of the files in the three-dimensional space.

3. The system of claim 1, wherein each file corresponds to a photographic image.

4. The system of claim 1, wherein the means for navigating through the three-dimensional space is selected from the group consisting of a mouse, a pointer, a joystick, a touch sensitive device, and an interactive feedback glove.

5. The system of claim 1, wherein each of the at least two attributes corresponds to a numerical value, and the numerical values locate the file in at least two dimensions when viewed in the three-dimensional space.

6. The system of claim 1, further comprising means for rendering the at least two attributes in three-dimensional space with respect to a particular vantage point.

7. The system of claim 1, further comprising means for adjusting the vantage point as a user navigates through the three-dimensional space.

8. The system of claim 7, wherein the means for adjusting the vantage point as a user navigates through the three-dimensional space scales the three-dimensional space to retain visibility of each file.

9. The system of claim 1, further comprising means for accessing the three-dimensional space using a database query.

10. The system of claim 1, wherein at least one of the attributes represents time.

11. A method for organizing and navigating through files, comprising:
providing a plurality of files, each file comprising at least two attributes;
mapping the at least two attributes into at least two dimensions;
rendering the at least two attributes representing each file into three-dimensional space, where an icon represents each file; and
navigating through the three-dimensional space to view the icons representing each of the files.

12. The method of claim 11, wherein the attributes define the position of the files in the three-dimensional space.

13. The method of claim 11, wherein each file corresponds to a photographic image.

14. The method of claim 11, wherein each of the at least two attributes corresponds to a numerical value, and the numerical values locate the file in at least two dimensions when viewed in the three-dimensional space.

15. The method of claim 11, further comprising rendering the at least two attributes in three-dimensional space with respect to a particular vantage point.

16. The method of claim 11, further comprising adjusting the vantage point as a user navigates through the three-dimensional space.

17. The method of claim 16, further comprising scaling the three-dimensional space to retain visibility of each file.

18. The method of claim 11, further comprising accessing the three-dimensional space using a database query.

19. The method of claim 11, wherein at least one of the attributes represents time.

20. A system for organizing and navigating through files, comprising:
a plurality of files, each file comprising at least two attributes:
a first code segment for mapping the at least two attributes into at least two dimensions;
a graphical user interface for rendering the at least two attributes representing each file into three-dimensional space, where an icon represents each file; and
where the graphical user interface allows a user to navigate through the three-dimensional space to view the icons representing each of the files.

21. The system of claim 20, wherein the attributes define the position of the files in the three-dimensional space.

22. The system of claim 20, wherein each file corresponds to a photographic image.

23. The system of claim 20, wherein the graphical user interface receives commands from a device selected from the group consisting of a mouse, a pointer, a joystick, a touch sensitive device, and an interactive feedback glove.

24. The system of claim 20, wherein each of the at least two attributes corresponds to a numerical value, and the numerical values locate the file in at least two dimensions when viewed in the three-dimensional space.

25. The system of claim 20, wherein the graphical user interface renders the at least two attributes in three-dimensional space with respect to a particular vantage point.

26. The system of claim 20, wherein the graphical user interface adjusts the vantage point as a user navigates through the three-dimensional space.

27. The system of claim 26, wherein the graphical user interface scales the three-dimensional space to retain visibility of each file.

28. The system of claim 20, wherein the three-dimensional space is accessed using a database query.

29. The system of claim 20, wherein at least one of the attributes represents time.
